(19) United States
(12) Patent Application Publication
(10) Pub. No.: US 2003/0004828 A1
(43) Pub. Date: Jan. 2, 2003

(54) Prepaid card authorization and security system

(75) Inventor: John B. Epstein, McKinney, TX (US)

Correspondence Address: John B. Epstein, The MONee Group/Exchange Enterprises, Inc., Three Lincoln Centre, 5430 LBJ Freeway, Suite 1600, Dallas, TX, 75240, US

(73) Assignee: S/B Exchange Enterprises, Inc.

(21) Appl. No.: 10/103,556

(22) Filed: Mar. 20, 2002

Related U.S. Application Data
(63) Continuation-in-part of application No. 09/561,206, filed on Apr. 27, 2000.
(60) Provisional application No. 60/277,500, filed on Mar. 21, 2001.

(51) Int. Cl. G06F 17/60

(52) U.S. Cl. 705/26

(57) ABSTRACT

A method to facilitate commerce over a computer network utilizing a prepaid account code. A potential consumer desiring to purchase goods or services over a computer network purchases the account code or card. To purchase goods or services, the consumer utilizes the card and a secret code at any seller web site, accessed via a computer network, such as the Internet. The seller web site verifies the validity and balance of the money card when the account code and secret code are utilized to purchase goods or services. Upon receiving authorization from the money card exchange, the seller executes the purchase and the money card exchange updates the money card balance in a database. In this manner the account code system facilitates commerce over a computer network.

This application claims benefit of U.S. Provisional Patent Application Ser. No. 60/277,500, filed on Mar. 21, 2001, and is a continuation-in-part of co-pending U.S. patent application Ser. No. 09/561,206, filed on Apr. 27, 2000, disclosures of which are hereby incorporated by reference in their entirety.

### FIELD OF THE INVENTION

This invention relates generally to network communications and database maintenance and in particular to a system to facilitate Internet commerce.

### BACKGROUND OF THE INVENTION

Advances in computer technology and communication technology allow for highspeed computer and communication networks. Simultaneous with the advances in the speed and capability of computer networks, other technological advances allow a large percentage of consumers to purchase access, in the form of computers and network service provider subscriptions, to these computer networks. While numerous computer networks exist, one of the most widely known networks is commonly referred to as the Internet. The Internet is a worldwide packet switched computer network having numerous Internet servers, routers and hubs, and can be accessed via personal computers. Numerous individuals throughout the world have access to the Internet via a direct connection or via an Internet service provider. Once connected to the Internet, and in particular, the World Wide Web (WWW), individuals may move from web site to web site to obtain information or download data.

As commonly occurs in modem society, numerous businesses, sellers and retailers have moved to capitalize on this new trend. Business owners and managers have realized the potential of the Internet to increase sales of goods or services. Using the Internet, consumers can utilize their personal computer and Internet access to connect to a seller's web site and order goods and services. This frees the consumer from having to travel to and from the store, risk finding an item out of stock, and waiting in line to purchase goods or services. Hence, the age of Internet retail has emerged.

To hasten the rush of Internet shoppers, sellers have established numerous methods and apparatus to accept payment from a consumer shopping via the Internet. These various methods include payment via credit card, bankcard, personal check or cash-on-delivery (COD).

While it is possible to complete transactions using these methods, numerous drawbacks exist with regard to each payment option. In the case of credit card, bank card, and personal check payment systems, consumers are concerned that revealing confidential financial information over a computer network may result in the confidential information being compromised either by an unscrupulous seller or by an unknown computer hacker in search of credit card numbers, bank card numbers, or checking account information.

Another security issue arises when individuals or family members other than an individual in charge of finances are provided access to financial data, such as credit card numbers and the like. For example, if a child or worker desires to execute an Internet transaction, the financial data must be given to that person, which may result in excessive Internet purchasing or unauthorized use. Hence, individuals in charge of the financial data, such as a parent or financial department, may be reluctant to facilitate the Internet transaction.

In addition, individuals may not want to be identified with a particular transaction. Using a credit card, bank card or personal check, however, identifies the person executing payment and identifies the transaction, e.g. on a periodic statement or canceled check.

Many people may not qualify for credit cards or bankcards due to lack of income or previous credit problems. Because Internet transactions often depend on the using a credit card, such people may be excluded from Internet transactions because cash and checks are generally not accepted and may unreasonably hinder timely completion of the transaction. Additionally, COD payment options may be unacceptable to sellers because consumers often refuse to pay upon delivery.

Finally, person-to-person fund transfers via telephone or the Internet suffer from many similar problems. Most person-to-person fund transfer systems require that the user or users have an email account and also a checking account or credit card. Therefore, person-to-person fund transfers generally create security risks and problems with maintaining anonymity.

Although other methods and apparatus have been proposed to overcome these drawbacks, none have adequately met the existing needs of consumers and retailers. For at least one reason, the other proposed payment methods fail in some respect. For example, many proposed solutions are too complicated in that they require consumers to perform numerous additional steps, actions or application processes. Other proposed solutions do not provide adequate security or anonymity, while other solutions are simply too expensive due to numerous third parties that must be involved to facilitate the transaction. Accordingly, improved systems and methods for paying for online transactions would be useful.

### SUMMARY OF THE INVENTION

In accordance with the present invention, a transaction system is provided to facilitate consumer transactions over a computer network. The present invention facilities Internet commerce by enabling a consumer to purchase goods and services over the Internet without having to use cash, checks, credit cards, or bank cards. In one embodiment, account codes are utilized. The account codes may be imprinted on cards or any other structure or surface or transmitted to the consumer via a network. Consumers access these account codes in any number of ways by paying for such account codes.

Each account code identifies an account that has a monetary balance associated with the account. In one embodiment a single oversight entity oversees the creation and accounting for each account code. This entity oversees the creation of these account codes, maintains records of the account codes with associated balances and serves as a monetary exchange for payments between account code purchasers and sellers.

To realize the advantages of the present invention, an individual, such as an Internet consumer may purchase the account code from a code retailer. Having obtained an account code, the consumer may utilize the account code at one or more Internet web sites that accept the account code system as a form of payment to obtain products, e.g., goods or services. By providing the account code to the web site of the seller, the consumer may authorize a transfer from the balance associated with the account to the seller as payment. In this manner, the Internet seller is compensated for the products sold or otherwise provided to the consumer. The balance associated with the account may be updated to reflect the purchase, e.g., by subtracting the amount of the purchase from the balance. After the seller receives payment from the code entity, the seller may send or otherwise provide the products to the consumer. It is anticipated that this process may occur rapidly over one or more computer networks.

In addition, additional security features of the card may be introduced. The card may contain printed information such as a card number, an expiration date (if any), a fictitious first name, and a control number. When the consumer purchases the card or account code, the consumer may be given a card activation code generated by a random character generator. To activate the card, the consumer may access a card management web site and input information required to activate the card, e.g. the card activation code. Once the card management web site has verified this information to be valid, the web site may require the consumer to input a secret code that may be associated with the account code. After designating the secret code, the card cannot be used to transfer funds without inputting the secret code. Thus, only the consumer, not a third party who is not privy to the secret code, may use the card to make purchases.

The card system may also allow for person-to-person fund transfers. For example, a seller selling an item to a buyer may give the buyer certain information regarding their account code that would allow the buyer to transfer funds from the buyer's own account code or from another account such as a credit card or checking account. This transaction may be completed online or via a telephonic transfer system. Transactions in this form are not limited to buyer/seller transactions and may be used to transfer funds in a manner similar to wire transfers. For example, a parent may wire money to a child in order to add value to the child's account code. In addition, this method may be used to combine the value of two or more accounts held by the same person.

In accordance with another aspect of the present invention, a system is provided for managing a plurality of pre-paid money cards that includes an account database including account codes identifying respective accounts, account balances identifying funds available funds from respective accounts, and account activation codes associated with the respective accounts. An interface may be configured for receiving an account code and an account activation code from a consumer over a telecommunications network. An account manager may be coupled to the interface for accessing the account database to confirm that the received account activation code is associated with the received account code. The account manage may request a secret code via the interface from the consumer over the telecommunications network after the account manager has confirmed that the received account activation code is associated with the received account code, the account manager configured for adding the secret code received from the consumer to the account database such that the secret code is uniquely associated with the respective account code.

Optionally, the interface may be configured for receiving an authorization request comprising a fund request, an account code, and a secret code. Preferably, the authorization request excludes information personally identifying the consumer. The account manager may access the account database to confirm that the secret code is associated with the account code, and/or to confirm that the fund request does not exceed a balance of the account identified by the account code. A transfer system may be provided for transferring funds from the account after the account manager has confirmed that the fund request does not exceed the balance of the account identified by the account code. The account manager may deduct the fund request from the balance in the account database.

In accordance with yet another aspect of the present invention, a system is provided for anonymously transferring funds using pre-paid money cards that includes an account database including account codes identifying respective accounts, account balances identifying available funds associated with respective accounts, and authorization codes associated with respective accounts. An interface is provided for receiving an account code and an authorization code from a consumer or seller over a telecommunications network. An account manager is coupled to the interface for accessing the account database to confirm that the received authorization code is associated with the received account code. The account manager may be configured for transferring funds from the account after the account manager has confirmed that the fund request does not exceed a balance of the account identified by the account code, the account manager deducting the fund request from the balance in the account database.

In accordance with still another aspect of the present invention, a method is provided for securely transferring funds using an account database including a plurality of account codes and card activation codes, the account codes identifying accounts including respective account balances identifying available funds, the card activation codes uniquely associated with respective account codes. The account codes and associated card activation codes may be provided to one or more distributors or consumers. An account code and a card activation code may be received from a seller, distributor, or consumer via a telecommunications network. The account database may be accessed to confirm that the received card activation code is uniquely associated with the received account code. A secret code may be requested from the consumer via the telecommunications network, received from the consumer, and stored in the account database such that the secret code is associated with the account code. For example, the secret code may replace the card activation code, thereby providing an authorization code required for subsequent use of the account code. Thereafter, secured transactions may be permitted using the account code.

In accordance with yet another aspect of the present invention, a method is provided for securely transferring funds that includes purchasing or otherwise receiving an account code, the account code including an account balance and a card activation code associated therewith. The account code and the activation code may be sent via a telecommunications network, e.g., over the Internet, to an account manager to activate the account code. A query may be received from the account manager to provide a secret code to be associated with the account code after the account manager has activated the account code, whereupon a secret code may be sent to the account manager via the telecommunications network.

In accordance with still another aspect of the present invention, a method is provided for a seller to sell products to a purchaser via a network. A prepaid account code and a secret code may be received from a purchaser, e.g., when the purchaser visits one or more web sites operated by the seller, the prepaid account code not identifying the purchaser. The seller may verify that the prepaid account code and secret code are valid, e.g., by initiating a database look-up to determine whether the prepaid account code and the secret code are valid. For example, the seller's server may transmit the prepaid account code and the secret code to an account manager, such as that described above, via a telecommunications network, e.g., the Internet. The account manager may then perform the confirmations described above, and provide the verification to the seller. The seller may receive payment for the products from a balance associated with the prepaid account code, e.g., from the account manager after the account manager has verified that an account balance associated with the prepaid account code is sufficient to pay for the products being purchased.

In accordance with still another aspect of the present invention, a method is provided for securely transferring funds using a prepaid account code, the prepaid account code including an account balance and an authorization code associated therewith. A transaction request may be received, e.g., by an account manager via a telecommunications network, e.g., directly from a consumer or from a seller. The transaction request may include a value, a prepaid account code, an authorization code, and a destination, and preferably excludes any information identifying the consumer. The account manager may confirm that the authorization code is associated with the prepaid account code, and/or that the value does not exceed the account balance associated with the prepaid account code. Once confirmed, the value may be debited from the account balance associated with the prepaid account code, and the value may be transferred to the destination.

In one embodiment, the destination may be a different prepaid account code, and the value may be transferred to the different prepaid account code via the telecommunications network. Alternatively, the transaction request may be received from a vender, and the destination may be a vender account associated with the vender.

The present invention may allow a consumer to shop on the Internet for products, e.g., goods and/or services, while still maintaining secrecy as to their identity. Further, the account code may be purchased with cash by an individual who does not qualify for a credit card or checking account. Other objects and features of the present invention will become apparent from consideration of the following description, taken in conjunction with the accompanying drawings.

### BRIEF DESCRIPTION OF THE DRAWINGS

FIG. 1 is a block diagram illustrating the relationship between various aspects of one embodiment of the present invention.

FIG. 2 illustrates an exemplary money card as might be utilized with the present invention.

FIG. 3 illustrates a block diagram of one exemplary embodiment of the present invention.

FIG. 4 illustrates various types of money cards.

FIG. 5 illustrates exemplary data fields in an exemplary embodiment of a card database.

FIG. 6 illustrates exemplary data fields in an exemplary embodiment of a seller database.

FIG. 7 illustrates exemplary data fields in an exemplary embodiment of a promotion database.

FIG. 8 illustrates exemplary data fields in an exemplary embodiment of a transaction database.

FIG. 9 illustrates exemplary data fields in an exemplary embodiment of a card sales database.

FIGS. 10A and 10B illustrate a flow diagram of an exemplary method of using a card having an account code, in one embodiment of the present invention.

FIGS. 11A and 11B illustrate an operational flow diagram of an exemplary method of operation of the present invention.

FIG. 12 illustrates an operational flow diagram of an exemplary method of operating of a promotions sub-routine of the present invention.

FIG. 13 illustrates an operational flow diagram of an exemplary method of performing a person-to-person fund transfer.

### DETAILED DESCRIPTION OF THE PREFERRED EMBODIMENTS

1. Overview of the Invention

The present invention provides improved systems and methods for facilitating the purchase of goods or services and the transfer of funds over a computer network. As recited above, purchasing goods over a computer network, such as the Internet, is growing. The present invention facilities Internet commerce by providing systems and methods for a consumer to purchase using prepaid cards. As used herein, a “consumer” may include an individual or an institution, such as a business. Each card includes one or more account codes that identify an account and a balance of that account. The account code may be associated with or imprinted on a card or paper, or transmitted via the network itself. The characters of the account code can comprise letters and/or numbers. In one embodiment, a single oversight entity oversees the creation and accounting for each account code. For purposes of understanding, this oversight entity is referred to herein as a money card exchange. The money card exchange oversees the creation of these account codes, maintains records of the accounts with associated balances and serves as a monetary exchange for payments between consumers and sellers. In a preferred embodiment, the consumer is able to add value to the account. Person-to-person transfers to and/or from an account code are also possible.

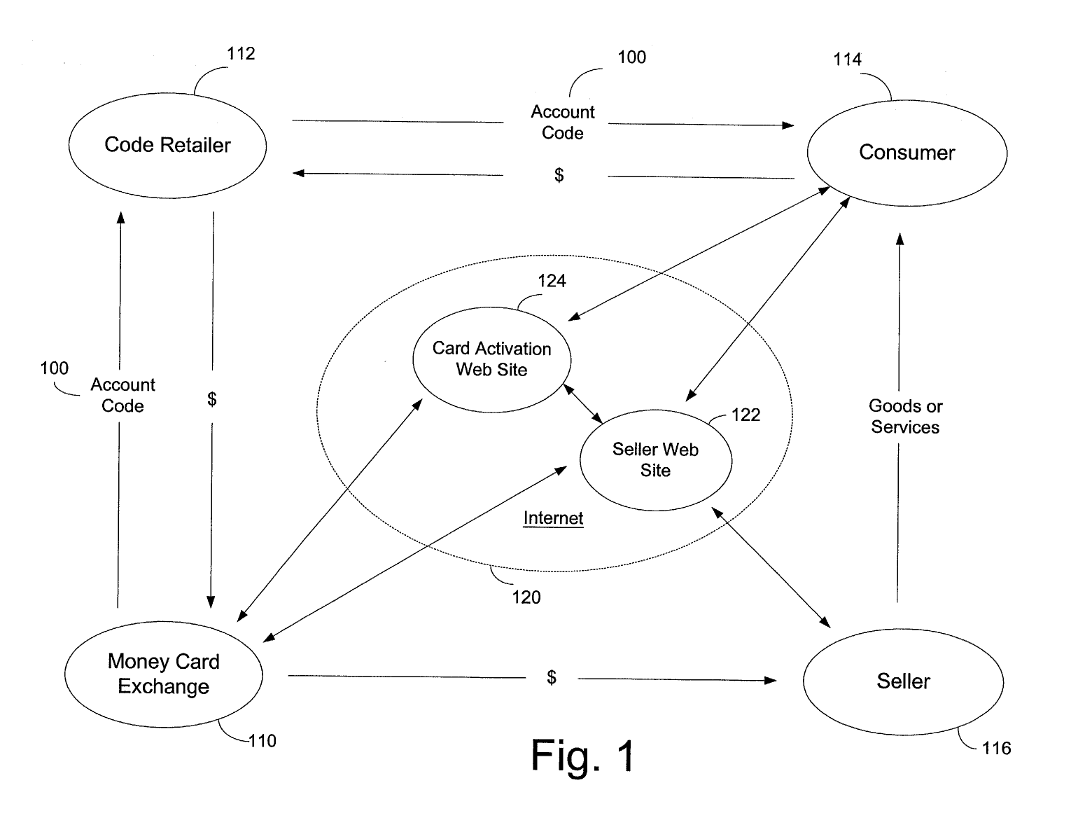

Turning now to FIG. 1, to realize the advantages of the present invention, a consumer 114 purchases an account code 100 from any of a number of various convenient locations, referred to herein as a code retailer 112. It is anticipated that a consumer 114 might purchase an account code 100 at a market, convenience store, or computer store. A consumer 114 may also purchase an account code 100 via the telephone or a network, such as the Internet 120. For example, in exchange for a fifty dollar card having an account code balance of fifty dollars, a consumer 114 would pay the code retailer 112 in any acceptable form, such as cash, credit card, bank card, checking account number and routing number, account code, check, or COD.

Having obtained an account code 100, the consumer 114 may utilize an account identified by the account code at any of a number of seller web sites 122 to pay for goods or services from a seller 116. By providing the account codes 100 via the Internet 120 to the seller web site 122, the consumer 114 facilitates a transfer of payment from the account to the seller 116. In one embodiment, a money card exchange 110 maintains the account and account code 100 and ensures payment from the account to the seller 116. Likewise, the money card exchange 110 maintains and updates the available balance associated with each account. In this manner, the account may be used one or more times until the balance in the account is depleted. Once the account balance is zero, the account is closed unless the card is refueled, and the consumer 114 may no longer obtain goods or services using that particular account code 100. The balance of several accounts can be consolidated into a single account if desired.

Additional details regarding using the account code system and the systems that enable such use are described below in greater detail.

2. Exemplary Environment

One exemplary environment particularly well suited for using a code system of the present invention is the Internet 120. As is commonly known in the art, the Internet 120 comprises a world-wide network of computers configured to exchange, store and display information. Located on storage media of the computers that comprise the Internet 120 are data and code to display information, such as web pages, to individuals having access to the Internet. Internet access, i.e. getting “on-line,” is most commonly provided via an Internet service provider, such as America-On-Line or Earthlink.

Sellers 116 maintain numerous web pages on the Internet 120 in an effort to sell goods and services. These web pages include interactive software to facilitate payment for goods purchased by consumers 114.

In reference to FIG. 1, a block diagram of the various aspects of the present invention are shown. A money card exchange 110 is responsible for establishing account codes 100, which in at least one embodiment, are imprinted on cards. The money card exchange 110 maintains a database of account code numbers with associated accounts and balances.

The money card exchange 110 communicates with a code retailer 112. The code retailer 112 can comprise a convenience store, retail store, vending machine, or an on-line vendor. Alternatively, account codes 100 can be purchased via mail order or by telephone. The money card exchange 110 sells large numbers of money cards, i.e. account codes 100, or cards imprinted with account codes 100 to the code retailer 112. Hence, account codes 100 are exchanged for payment to the money card exchange 110 either at time of sale to the code retailer 112 or after the code retailer 112 sells the account code 100 to a consumer 114.

The code retailer 112 in-turn sells the cards having account codes 100 associated therewith to individual consumers 114. The consumer 114 pays the code retailer 112 an amount equal to, greater than, or less than the denomination of the card, i.e. the balance of the account.

The card may be activated when sold to the consumer 114 or may require the consumer 114 to activate the card before usage. In a preferred embodiment and as further discussed below, the consumer 114 activates the account code 100 by accessing a card management web site 124 and entering information regarding the account code 100. The card management web site 124 communicates with the money card exchange 110 via the network. Once the money card exchange 110 verifies the accuracy of the account code information, the money card exchange 110 activates the account code 100.

After the consumer 114 activates the account code 100, the consumer 114 may access a web site, such as a seller web site 122, to utilize the account code 100 to purchase goods or services. The seller web site 122 includes software capable of accepting the account code 100 to pay for goods or services.

Upon purchasing goods or services at a seller web site 122, the seller web site 122 communicates with the seller 116 and the money card exchange 110 via the Internet 120. In response, the money card exchange 110 pays the seller 116 and the seller 116 provides the consumer 114 with the goods or services. In this manner, the seller 116 receives payment for the goods and services. The money card exchange 110 automatically deducts the purchase price from the balance of the account.

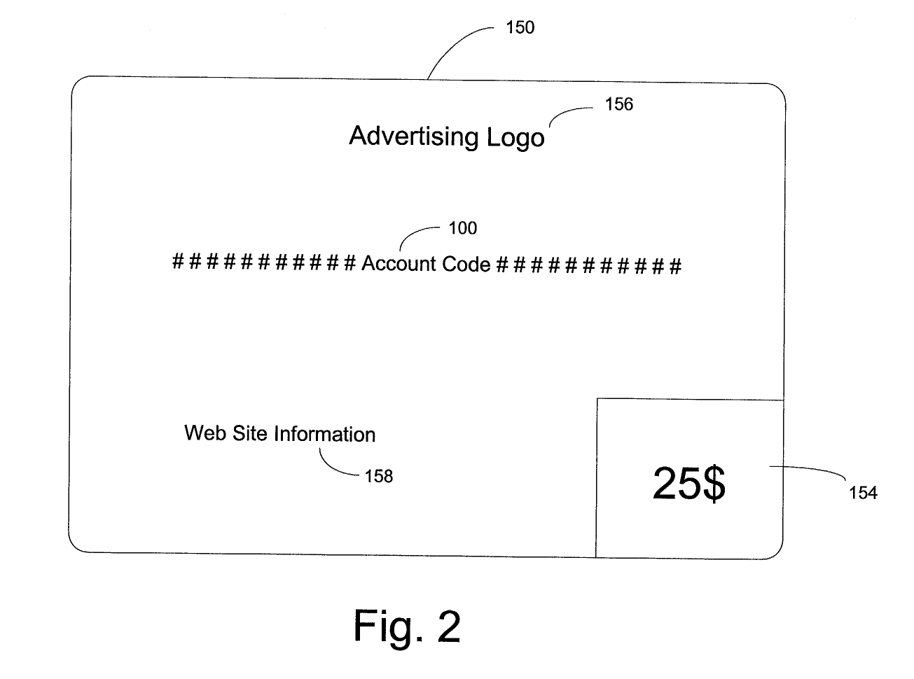

Turning now to FIG. 2, a top plan view of an exemplary card 150 is shown. As shown, the card 150 includes the account code 100 that may be utilized to obtain goods and services. The account code 100 may either be printed or imprinted on the face of the card. The card may also include a denomination or value 154 representing how much the card costs or is worth. In alternative embodiments, some form of advertising logo 156 may reside at the top of the card and instructions or an Internet web site address 158 may also reside on the money card 150. Various other embodiments of the present invention place the account code 100 on items other than a card. For example, the account code 100 may be purchased via an on-line service and delivered to the purchaser in an encrypted digital format. In other embodiments, the account code 100 may be placed on other items including but not limited to paper, e-mail, telegrams, phone messages, or any promotional items.

In a further embodiment, the card identifying the account code 100 may include additional security features. These additional security features not only enhance the anonymity of the account code 100, but may also prevent fraudulent use of the account code 100 by an unauthorized person. In a preferred embodiment, the account code 100 may be provided to the consumer 114 on a card identifying a magnetic strip. Stored on the magnetic strip may be information such as the account code 100, card number, expiration date (if any), transfer code (discussed further below), card activation code from a random character generator (discussed further below), a control number, a fictitious first name, etc. All or any part of the information stored on the magnetic strip may also be reproduced on the card itself.

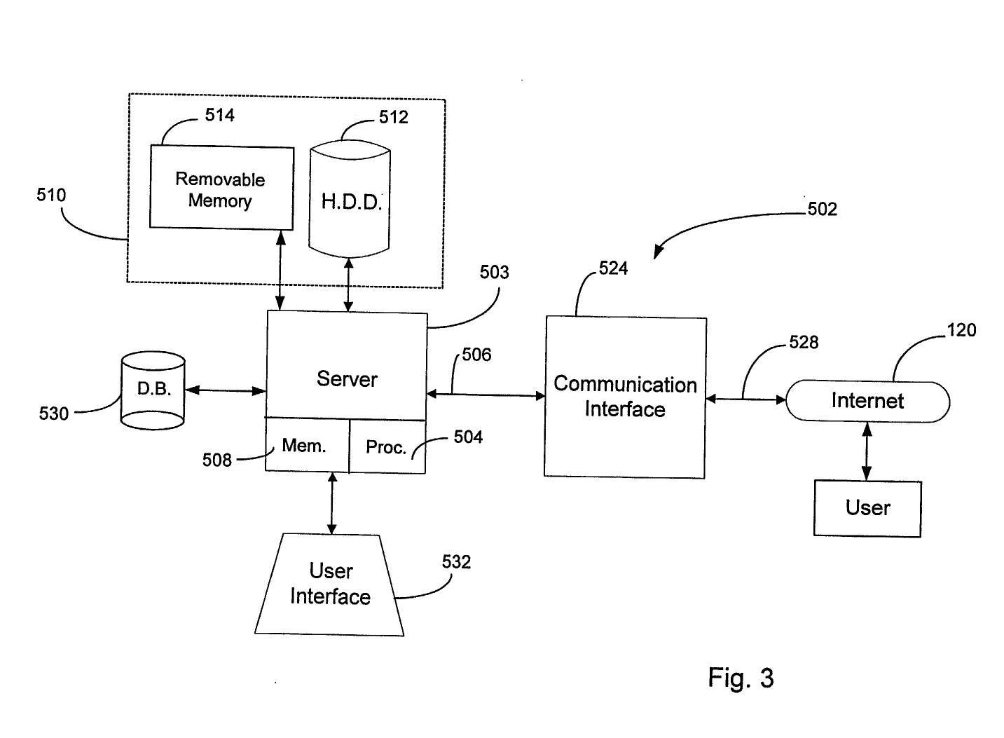

In FIG. 3, the apparatus of the user interface is described in more detail. The various embodiments, aspects and features of the invention described herein may be implemented using hardware, software or a combination thereof and may be implemented using a computing system having one or more processors. In fact, in one embodiment, these elements are implemented using a processor-based system capable of carrying out the functionality described with respect thereto. An exemplary processor-based system 502 is shown in FIG. 3 according to one embodiment of the invention. The computer system 502 includes one or more processors, such as processor 504. The processor 504 is connected to a communication bus 506. Various software embodiments are described in terms of this exemplary computer system. The embodiments, features and functionality of the invention as described above are not dependent on a particular computer system or processor architecture or on a particular operating system. In fact, after reading this document, it will become apparent to a person of ordinary skill in the relevant art how to implement the invention using other computer or processor systems and/or architectures.

Processor-based system 502 comprises a server 503 with a main memory 508, preferably random access memory (RAM), and can also include a secondary memory 510. The secondary memory 510 can include, for example, a hard disk drive 512 and/or a removable storage drive 514, representing a floppy disk drive, a magnetic tape drive, an optical disk drive, etc. The removable storage drive 514 reads from and/or writes to a removable storage medium (not shown) in a well known manner. Removable storage media represents a floppy disk, magnetic tape, optical disk, etc. which is read by and written to by removable storage drive 514. As will be appreciated, the removable storage media includes a computer usable storage medium having stored therein computer software and/or data.

In alternative embodiments, secondary memory 510 may include other similar means for allowing computer programs or other instructions to be loaded into computer system 502. Such means can include, for example, a removable storage unit and an interface. Examples of such can include a program cartridge and cartridge interface (such as that found in video game devices), a removable memory chip (such as an EPROM, or PROM) and associated socket, and other removable storage units and interfaces which allow software and data to be transferred from a removable storage unit to computer system 502.

Computer system 502 can also include a communications interface 524. Communications interface 524 allows software and data to be transferred between computer system 502 and external devices via a network such as the Internet 120. Examples of communications interface 524 can include a modem, a network interface (such as, for example, an Ethernet card), a communications port, a PCMCIA slot and card, etc. Software and data transferred via communications interface 524 are in the form of signals that can be electronic, electromagnetic, or optical or other signals capable of being received by communications interface 524. These signals are provided to communications interface via a channel 528. This channel 528 carries signals and can be implemented using a wireless medium, wire or cable, fiber optics, or other communications medium. Some examples of a channel can include a phone line, a cellular phone link, an RF link, a network interface, and other communications channels.

In this embodiment, the communication interface 524 connects to the Internet 120 or some other computerized network capable of exchanging information, such as account codes 100, to other computers to thereby facilitate commerce.

A database 530 communicates with the server. As known by those of ordinary skill in the art, the database 530 stores and retrieves records based on record numbers or other identifiers. The database 530 stores account codes 100, account balances, and optionally other information, as discussed in more detail below.

A user interface 532 connects to the server 503 to allow a money card exchange employee or system operator to interface with the software running on the server 503, database 530 and communication interface 524. In one embodiment, the user interface 532 comprises a video display unit, a keyboard, and/or a graphical interface device, such as a mouse or trackball.

In this document, the terms “computer program medium” and “computer usable medium” are used to generally refer to media such as a removable storage device, a disk capable of installation in disk drive 512, and signals on channel 528. These computer program products are means for providing software or program instructions to the computer system 502.

Computer programs (also called computer control logic) are stored in main memory 508 and/or secondary memory 510. Computer programs can also be received via communications interface 524. Such computer programs, when executed, enable the computer system 502 to perform the features of the present invention as discussed herein. Accordingly, such computer programs represent controllers of the computer system 502.

In an embodiment where the elements are implemented using software, the software may be stored in, or transmitted via, a computer program product and loaded into computer system 502 using removable storage drive 514, hard drive 512 or communications interface 524. The control logic (software), when executed by the processor 504, causes the processor to perform the functions of the invention as described herein.

In another embodiment, the elements are implemented primarily in hardware using, for example, hardware components such as PALs, application specific integrated circuits (ASICs) or other hardware components. Implementation of a hardware state machine so as to perform the functions described herein will be apparent to persons skilled in the relevant art(s). In yet another embodiment, elements are implemented using a combination of both hardware and software.

This is but one of many different configurations that may be utilized to embody the present invention. Other configurations of hardware are fully contemplated by the present invention.

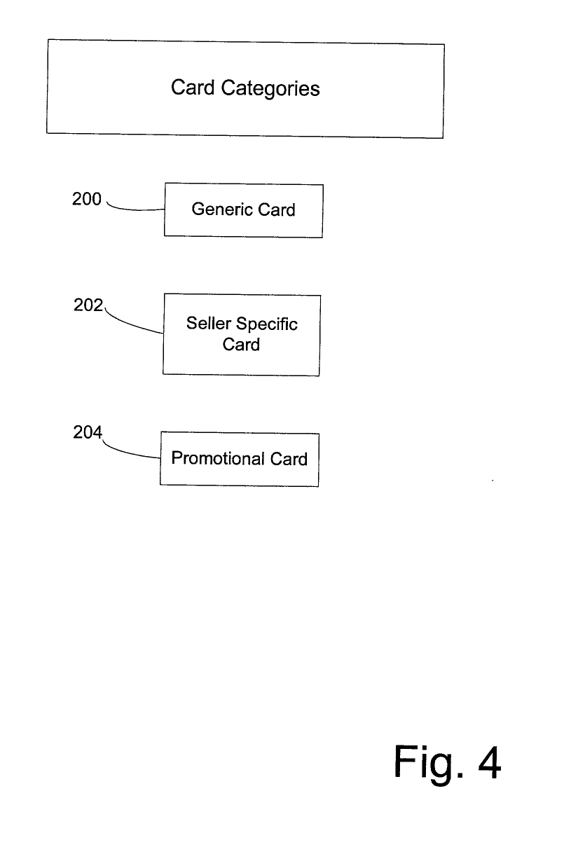

FIG. 4 presents several categories into which cards are grouped depending on the features of the cards. While all cards and the associated network configured in accordance with the present invention share a basic method of operation, different types of cards can exist. One type of cards comprises generic cards 200. A generic card is a basic card that can be used at any Internet web site that accepts the card as a method of payment.

Another type of card can comprise a seller specific card 202. A seller specific card 202 differs from a generic card 200 in that it must be used at a specific seller web site 122.

Another type of card comprises a promotional card 204. A promotional card 204 comprises a card specifically associated with one or more other promotions or incentives to utilize the card at a particular site or for a particular type of product or service. The card may be without cash value and be promotional only (like a coupon). For example, in some cases cards can be distributed via magazines, direct mail or handouts. Non-promotional cards can also be distributed via magazines, direct mail or handouts. The recipient may take a promotional card into an approved retailer, like Wal-Mart or Blockbuster, to add value to the balance of the account. The recipient may simply hand over cash and the card to a person at the retailer. The retailer may enter the account code, e.g. by swiping a magnetic strip on the card into a credit/debit card reader machine and entering the amount the person gave them (i.e. $25, $50, $500 etc.) into the cash register/reader. The transaction may be transmitted through the retailer's system to the money card exchange 110 which completes the transaction and gives the account value. The recipient then can go to any web site that accepts the card and use it.

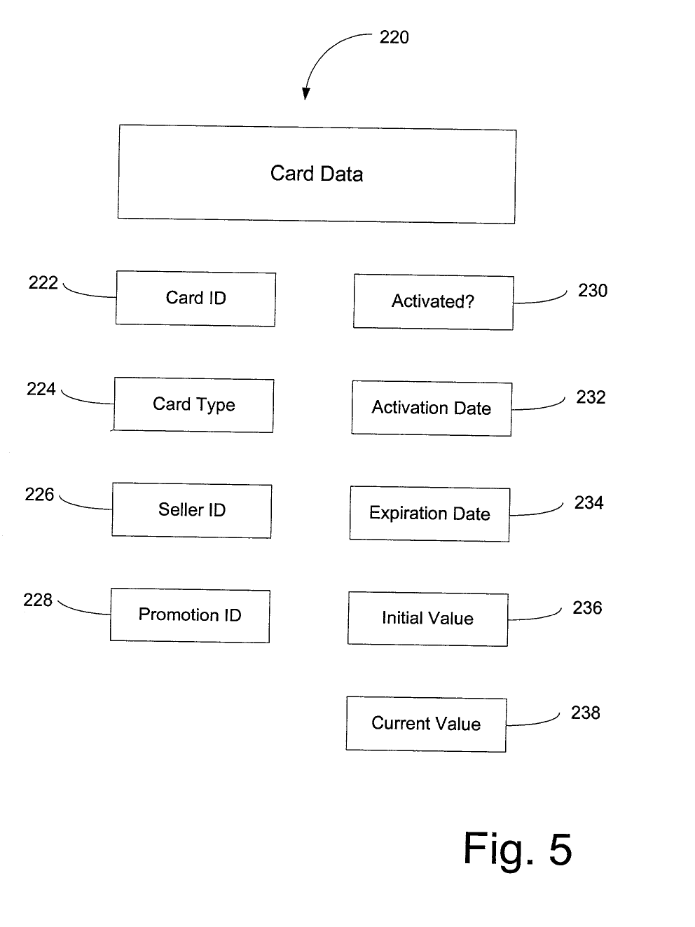

FIGS. 5-9 illustrate the organization and content of the database records and sub-records of one exemplary embodiment of the present invention. In this exemplary database configuration, the data is divided into five main categories. The five exemplary categories are card data 220, seller data 246, promotions data 256, transactions data 270, and card sales data 300. Each of these categories is discussed below in greater detail.

Card Data

One aspect of the database data comprises card data 220. Card data 220 comprises data stored by the money card exchange 110 that concerns the card or the account code 100 on the card. In this exemplary embodiment, the data broadly categorized as card data includes a card ID 222. The card ID 222 comprises the account code 100 entered by a consumer 114 to obtain goods or services. This account code 100 identifies the card and is the primary identifier of the account. The card data 200 also includes the card type 224 to identify whether the card is a generic card 200, a seller specific card 202, or a promotional card 204.

A seller ID 226 uniquely identifies, with an identification number, each seller 116 and their seller web site 122 that is configured to accept card transactions. This seller ID 226 is used to track transactions to a seller 116 and to facilitate transferring funds to the seller 116. A promotion ID field 228 is used if a promotion is applicable to the card.

An activation completed field 230 and an activation date field 232 identify if a consumer 114 has activated the money card and, if so, on what date. An expiration date field 234 identifies the date of expiration of the card, if such applies.

An initial value field 236 stores the initial monetary value of the card while a current value field 238 stores the current available balance or value of the card based on previous purchases.

Seller Data

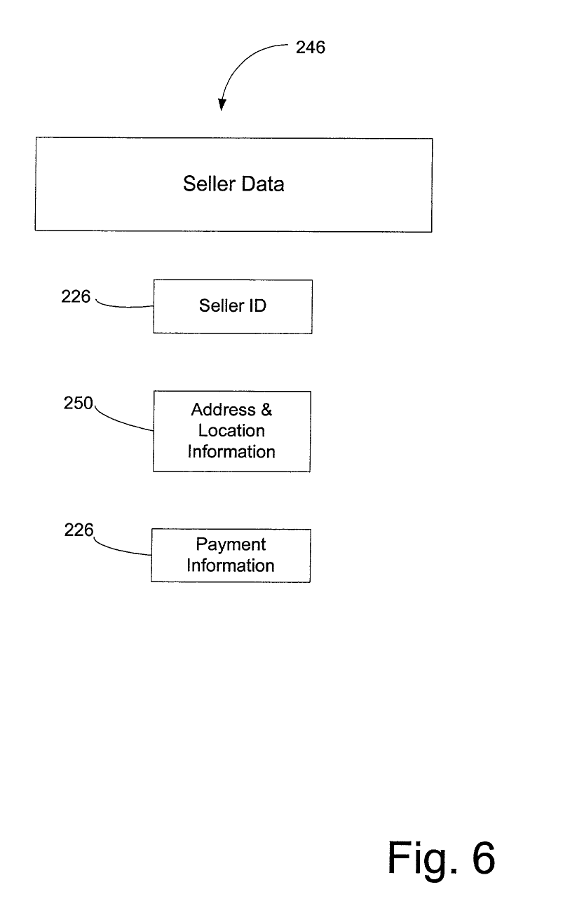

As shown in FIG. 6, seller data 246 comprises data fields specific to each particular seller 116 that utilizes the card system. The fields of the seller data comprise a seller ID 226, described above, an address field 250 to store the address information regarding each particular seller 116, and payment information field 252 to store payment information.

Promotions Data

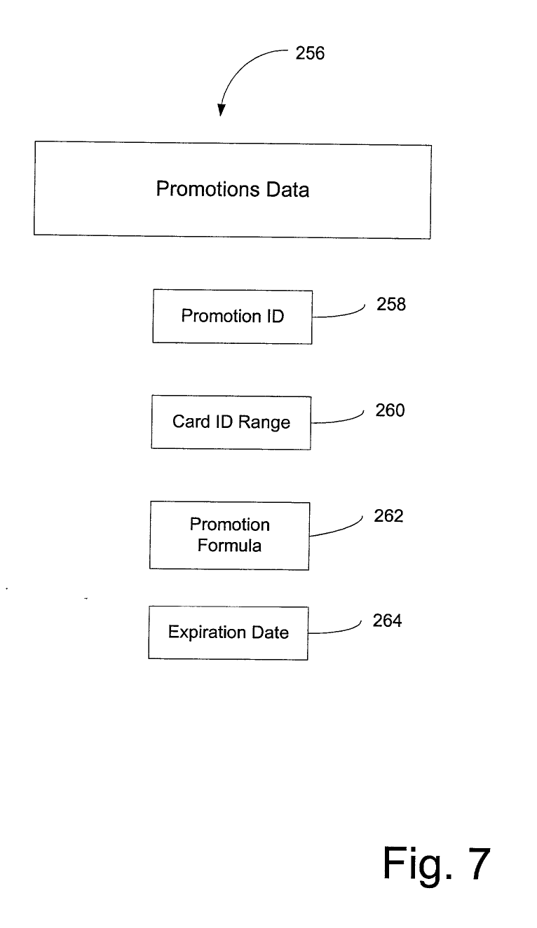

As shown in FIG. 7, the promotions data fields 256 store data regarding the promotions available and the promotions associated with each card. A promotions ID 258 identifies a particular promotion with an identifying code. A card ID range 260 identifies the cards, by card ID 222 (or account code 100), that are issued under a particular promotion. In one embodiment a particular card ID range 260 is assigned a particular promotion.

The promotion formula 262 identifies the particular promotion associated with each promotion or promotion ID 258, such as 10% off all purchases, or buy one get one for ½ price. Of course, these promotions are listed by way of example and not limitation. More complex promotions may be utilized as desired. An expiration date 264 identifies the expiration of the particular promotion.

Transactions Data

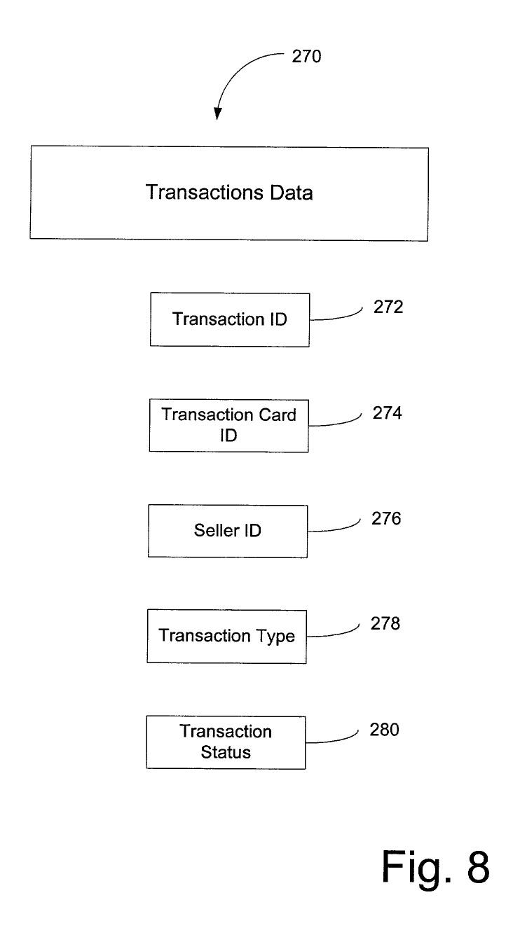

As shown in FIG. 8, the transactions data 270 contains information regarding transactions that have occurred for a card. The system tracks the transactions for each card thereby maintaining detailed records of account balance and seller payment amounts. A transactions ID 272 and associated transaction card ID 274 uniquely identify each transaction. A transaction type 278 stores data identifying the type of transactions, including whether it is a purchase, return, or use of a promotion item. A transaction status field 280 stores information identifying the status of each particular transaction.

Card Sales Data

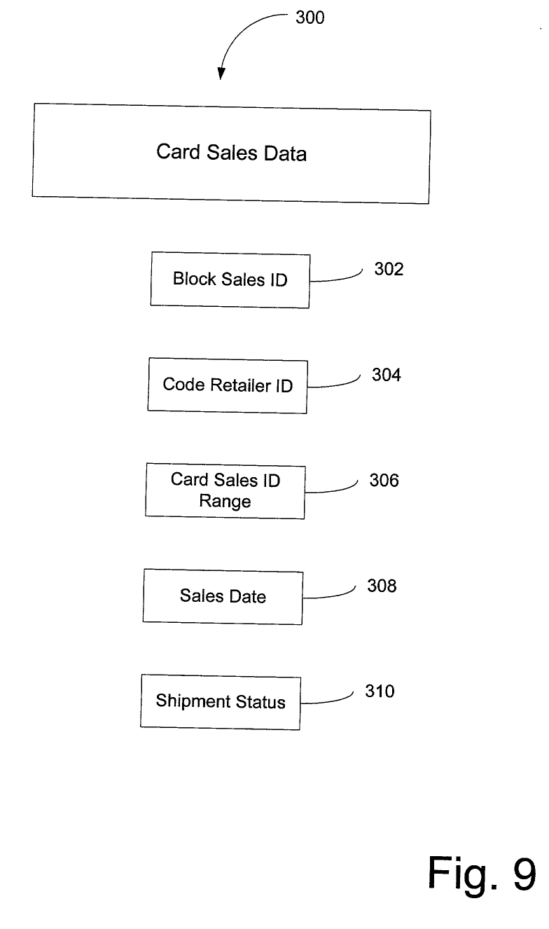

As shown in FIG. 9, the money card sales category 300 stores data regarding the sale of cards or account codes 100 to code retailers 112. For every sale of account codes 100 to a code retailer 112, a block sales ID 302 is used to identify which account codes 100 were sold to a code retailer 112. A code retailer ID 304 stores a numeric code that uniquely identifies the code retailer 112 to which the account codes 100 were sold.

A card sales ID range 306 identifies the range of account codes 100 that were sold in the card transaction identified by the unique block sales ID 302. A sales date field 308 and a card shipment status field 310 store data regarding the date of sale and shipping information.

This manner of data is utilized by the card system during operation. The functionality and importance of the various types of data are discussed in more detail below.

Operation

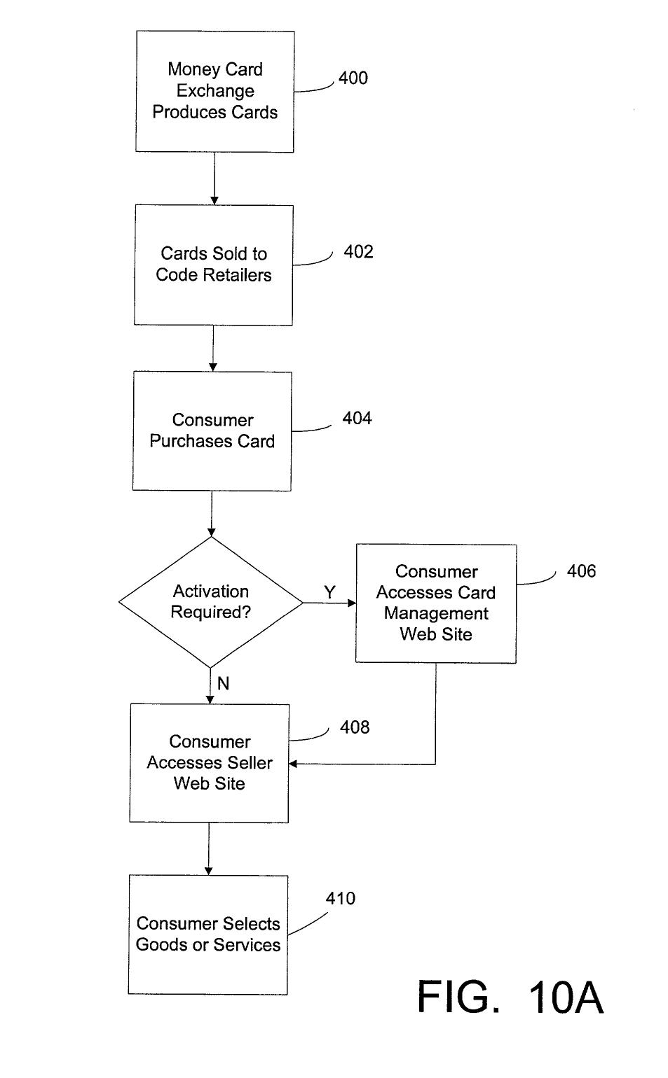

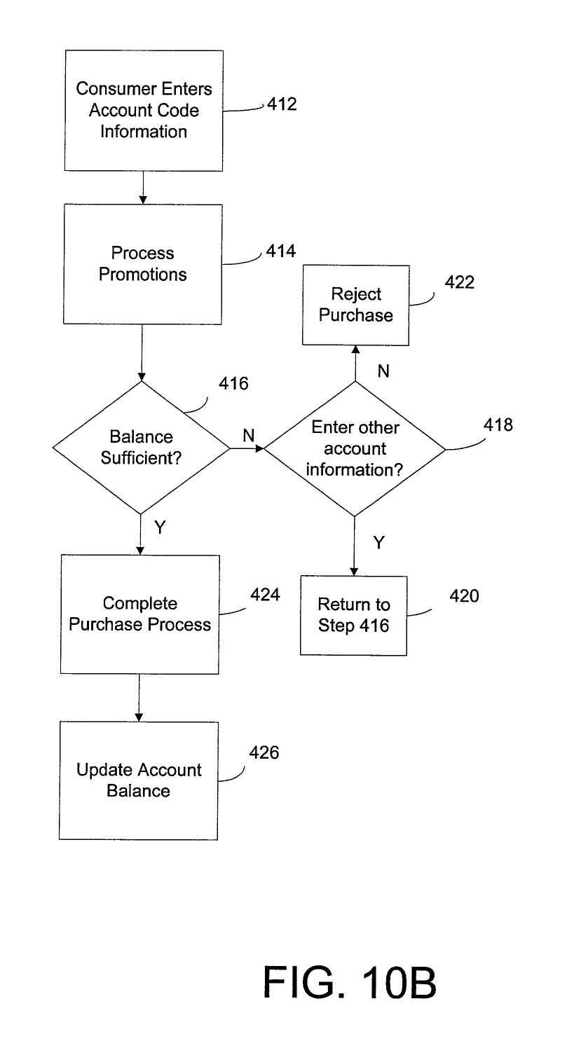

It is contemplated that various methods of operation may be adopted in conjunction with the present invention. FIG. 10 illustrates one exemplary method for establishing and utilizing one embodiment of the present invention. The present invention is not limited to the method illustrated in FIG. 10 as various other methods and systems may be used to implement the process.

At step 400, cards are manufactured by the money card exchange 110. At step 402, the cards are sold to code retailers 112. As remuneration for the sale of the cards, the code retailers 112 transfer funds to the money card exchange 110 at step 402 or remuneration may not occur until sale to the consumer 114 (step 404) or upon periodic processing. For example, the code retailer 112 may send remuneration to the money card exchange 110 based on sales of the cards to consumers 114 for a given month or quarter. In various other embodiments, the present invention may utilize items other than cards on which to distribute the account codes 100. In one embodiment, the account codes are delivered electronically or printed on paper, other promotional devices or sent via fax or phone.

Next, at step 404, consumers 114 desiring to use the cards pay code retailers 112 for the account codes 100. It is contemplated that such purchases may occur via a computer network, via telephone, or in-person at the site of the code retailer 112. In one configuration, the account code 100 is automatically active at the time of sale or transfer to the code retailer 112. In another configuration, the account code 100 is activated at the time the card is first used to purchase goods or services at a retailer or seller 116.

In other embodiments, it is contemplated that an independent step of activation can be utilized. If activation of the card is required, at step 406, the consumer 114 utilizes a connection with a computer network or a telephone to activate the account code 100 in the card database. Accordingly, the consumer 114 accesses a card management web site 124 and provides the account code 100 and/or other information on the card. The card management web site 124 then communicates with the database of the money card exchange 110 via the computer network. The money card exchange 110 verifies that the account code 100 is valid and activates the account code 100. Upon activation, the account code 100 may be used to purchase goods or services from any retailer or seller 116 accepting the account codes 100 as a form of payment. If activation of the account code 100 is not required, the consumer 114 may proceed directly to step 408.

At step 408, the consumer 114 accesses a seller web site 122. At step 410, the consumer 114 selects goods to purchase. At step 412, the consumer enters account code information.

Next, at step 414, the seller web site and/or the money card exchange 110 process any promotions associated with the account code 100 or the purchase of goods or services being obtained with the account code 100. FIG. 12, discussed below, discusses one exemplary method of promotion processing in greater detail.

Next, at step 416, the money card exchange 110 determines if the balance of the account is sufficient to complete the purchase. To determine if the balance of the account is sufficient, the money card exchange 110 interrogates the card database to obtain balance information. If the balance is not sufficient to complete the purchase, the process progresses to step 418, wherein other forms of payment may be utilized to supplement payment. In various other embodiments, other payment methods that may be utilized include but are not limited to additional account codes, credit cards, bank cards or direct bill procedures. At step 420, the consumer 114 may enter information for another account. After entering this additional account information, the process returns to step 416 to determine whether the consumer's balance is now sufficient. If adequate payment cannot be provided, the operation terminates the purchase at step 422.

If a sufficient balance is available from the account code 100, or if additional forms of payment have adequately supplemented the payment, the operation progresses to step 424 wherein the approval of the purchase is sent from the money card exchange 110 to the seller 116 or seller web site 122 so the purchase may be completed.

Thereafter, the balance of the account is updated at step 426, and the appropriate amount of money is sent from the account to the seller 116 in exchange for the goods or services. The consumer 114 can then access another seller web site 122 to make an additional purchase or exit the network.

This is but one of many methods of operation for the establishment of cards, purchase of account codes 100, use of account codes 100, and verification process during account code 100 use. It is contemplated that those of ordinary skill in the art will envision other methods of use or variations on the described method of use, all of which are covered by the scope of the claims below.

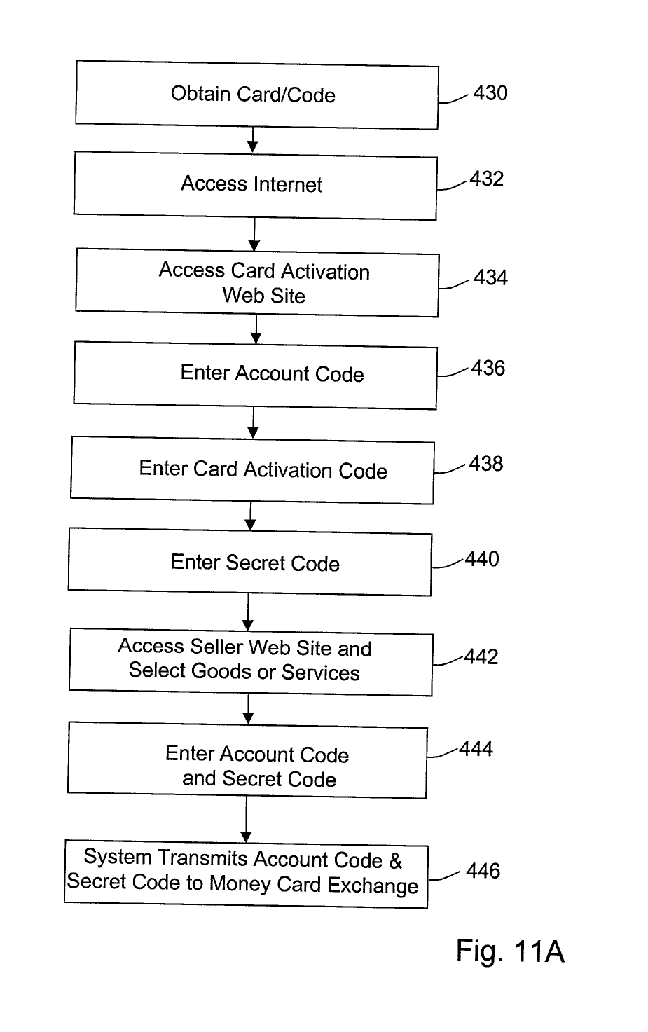

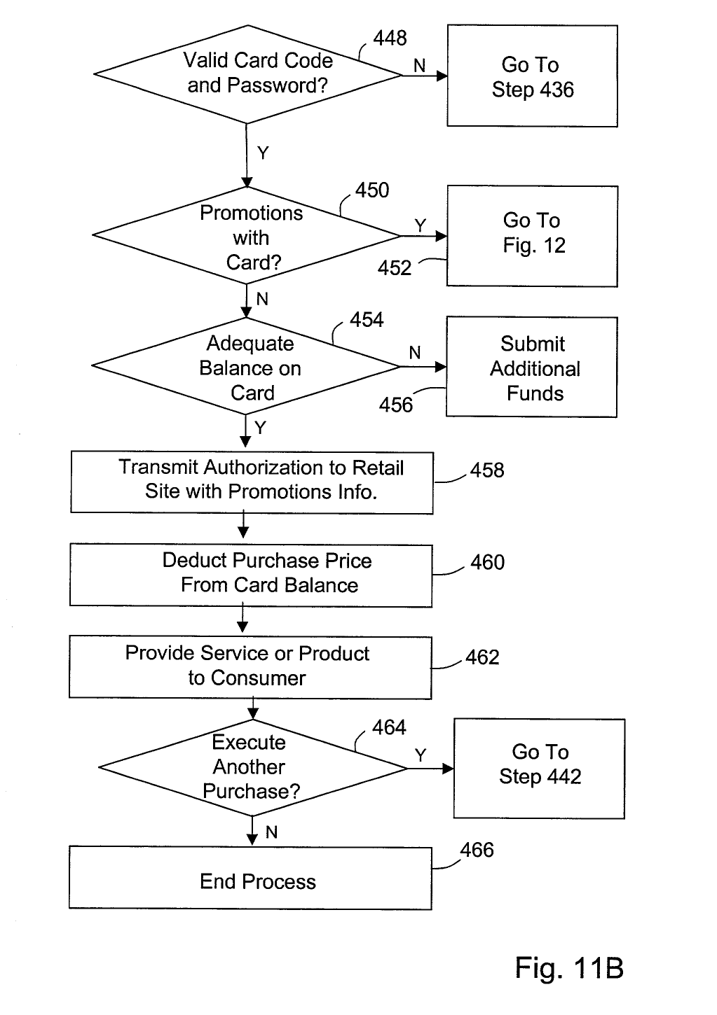

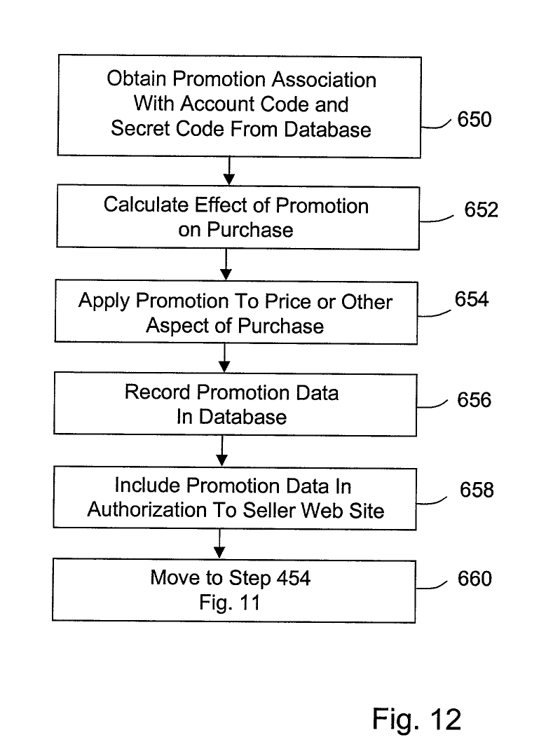

FIG. 11 illustrates an operational flow diagram of an exemplary method of operation of the present invention from the standpoint of a consumer 114 of an account code 100. At a step 430, the consumer 114 obtains a card. It is contemplated that the card may be obtained in any number of ways, for example, as a purchase, gift, prize or free promotion.

Once the consumer 114 has obtained the card, the consumer 114 may be given an account activation code 102 generated by a random character generator. In an exemplary embodiment, the card activation code 102 is a fictitious last name generated by a random character generator. This code may be provided to the consumer 114 in several manners, for example, a sticker attached to the card. After the consumer 114 has used the card activation code 102 to activate the card as described below, the sticker may be removed from the card and/or otherwise destroyed. In addition, the card activation code 102 may be printed on the card itself. In a preferred embodiment, the card activation code 102 is provided to the consumer on the consumer's receipt for purchasing the card. The card activation code 102 provides an additional security feature for the card by requiring that the consumer 114 enter this code in order to activate the card. As further discussed below, once the consumer 114 has entered the card activation code 102, e.g. at a card management web site 124, the consumer may be prompted by the card management web site 124 to enter a secret code 104 that becomes associated thereafter with the account, and may be required to initiate subsequent transactions utilizing the card.

If the consumer 114 loses the card activation code 102 or forgets the secret code 104, a support system may be provided to reset either code. For example, the consumer 114 may call a telephone support center and provide the support center representative with information such as the date and location of purchase, method of payment, account number used to purchase the card, transaction history of the card, etc. Upon verification, the support center representative may reset the card activation code 102 and/or the secret code 104.

Next, for a consumer 114 intending to utilize the card over a computer network, such as the Internet 120, at step 432, the consumer 114 accesses the network. At step 434, the consumer 114 may access a card management web site 124. At step 436 and step 438, the consumer 114 enters the account code 100 and the card activation code 102 for the card and transmits the account code 100 and the card activation code 102 to the card management web site 124. In another embodiment, the consumer 114 may enter information in addition to the account code 100 or in place of the account code 100 such as a card number, a portion of a card number, an initial balance of the card, purchase date, a fictitious first name, and/or any combination of this information. At step 440, the consumer 114 may be prompted by the card management web site 124 to provide a secret code 104 that may replace the card activation code 102. Therefore, once the consumer 114 has chosen and entered the secret code 104, the card activation code 102 may no longer be needed. The secret code 104 may provide security to limit an unauthorized person from utilizing the card.

In a preferred embodiment, the card management web site 124 may be a central web site for consumer management of the account code 100. Besides allowing the consumer 114 to activate the account code 100, the card management web site 124 may allow the consumer 114 to check the account balance or transaction history, change the secret code 106, transfer funds to or from the account code 100, set or change an email address associated with the account code 100, activate the account code 100 for ATM access, etc. In a further embodiment, the card management web site 124 may provide a lock-out feature to prevent the card from being used at certain seller web sites, such as adult web sites. Additionally, the card management web site 124 may provide a purchase limitation feature allowing the account holder to impose limitations on the amount spent from the account code 100 on a daily, weekly, monthly, or other periodic basis.

After activating the card, at step 442, the consumer 114 accesses a desired seller web site 122 to purchase goods or services. At the seller web site 122, the consumer 114 selects goods or services. Upon selecting the goods or services, the consumer 114 is prompted to enter payment information. If the card is an accepted form of payment, the consumer 114 selects the card as the desired payment method and enters the account code 100 and secret code 104 at step 444.

At step 446, the seller web site 122 records the account code 100 and secret code 104 and/or forwards data to the money card exchange 110 including but not limited to the account code 100, secret code 104, seller ID code 226, and the purchase price of the item.

At a decision step 448, the money card exchange 110 determines whether the account code 100 and secret code 104 presented are valid. If the account code 100 and secret code 104 combination is not valid, at step 436, the money card exchange 110 informs the consumer 114 and/or seller 116 that the account code 100 is invalid. The consumer 114 may then be able to reenter the account code 100 and/or secret code 104.

If the account code 100 and secret code 104 are determined to be valid, the method progresses to a decision step 450 to determine if the card or purchase has an associated promotion. If at decision step 450, the method determines that there is a promotion associated with the transaction, the method progresses to a step 452 to execute a promotions sub-routine. The promotion sub-routine step 452 is discussed in more detail below in conjunction with FIG. 12.

Upon completing the promotion sub-routine or if there is no promotion associated with the transaction, the method progresses to a decision step 454 wherein the balance of the account associated with the account code 100 is compared to the amount of the purchase. If the balance is not adequate to cover the purchase, then the seller web site 122 prompts the consumer 114 concerning the deficiency. In various embodiments, the consumer 114 may then reconfigure his purchase such that the amount of the purchase is within the balance and/or some other form of payment may be used to supplement the account code 100. It is contemplated that these supplemental forms of payment may include additional prepaid cards, credit cards, checks, bank cards, personal checks, purchase order numbers, or send-a-bill requests.

Once the balance (and other payment forms) is sufficient to pay for the purchase, at step 458, the money card exchange 110 transmits a purchase authorization code 106 via the Internet 120 to the seller web site 122. The purchase authorization code 106 indicates to the seller web site 122 that the account code 100 is a valid payment method. In various configurations, additional other information is sent to the seller web site 122 such as the purchase price after promotions, a code associated with the good or service, date of purchase, the seller security code and any other information required by the seller 116 to be able to process the transaction.

At a step 460, the money card exchange 110 deducts the purchase price from the balance of the card. This preferably occurs only after the seller web site 122 has received instructions that the transaction is complete. Alternatively, step 460 may occur simultaneously with authorization transmission (step 458) to the seller web site 122.

At step 462, a process is initiated to provide the purchased goods or services to the consumer 114. This may comprise, but is not limited to, shipping the goods, ordering the goods to be made, or providing a product authorization code to the consumer 114 to obtain the goods or services.

Next, at step 464, the consumer 114 is queried whether he wants to make another purchase. If the consumer 114 chooses to make another purchase, the method returns to step 442. If the consumer 114 chooses not to make another purchase, the method terminates at end step 466. The consumer 114 is then free to exit from the computer network or go to another computer network site.

FIG. 12 illustrates an operational flow diagram of an exemplary method of operation of a promotions sub-routine. The promotions sub-routine is designated generally at step 452 of FIG. 11. After determining that a promotion is associated with a purchase, as shown in step 452 of FIG. 11, promotion data is obtained that is associated with the account code 100, secret code 104, or proposed purchase from the card database. Promotion data may include but is not limited to data regarding the type of promotion, such as percentage discount, free gift with purchase, award of purchase coupons or award points, or cash back award. The promotion data may also comprise data regarding the start date and expiration date of the promotion, the sponsor of the promotion or contact information regarding the promotion.

Next, at step 652, the effect of the promotion on the purchase is calculated. The effect of the promotion may comprise a percentage discount or some other form of adjustment to the purchase price. Next, at step 654, the promotion is applied to the price of the purchase or some other aspect of the purchase. This price or transaction summary is utilized for the basis of the purchase.

Next, at step 656, the promotion data and associated transaction are recorded in the database of the money card exchange 110. Thereafter, at step 658, the promotion data and adjustment in transaction price are included in the authorization data that is to be sent to the seller web site 122. The promotions sub-routine operation then returns to the operation of FIG. 11 at a step 454.

In a preferred embodiment, the account code system also allows for person-to-person fund transfers. Person-to-person transfers may take place in a variety of environments, such as transfers from a buyer to a seller or from a parent to a child.

A user intending to make a transfer of funds to or from an account code 100 may go to a code retailer 112, access the Internet 120, or complete the transfer over the phone. In order to have funds transferred into an account code 100, the account code holder may give the user (1) a transfer code and (2) an account code identifier. In a preferred embodiment, the transfer code only allows another party to transfer funds into the account. The account code identifier may comprise all or a portion of the account code 100 or another form of identification of the account code 100. Other forms of account code identifiers may be a fictitious first name, secondary card number, email address of the account code holder, etc. The account code identifier may also be any combination of the listed items.

The user may then input these numbers into the chosen transfer medium. For example, if the user accessed the card management web site 124, the user may select an option allowing for a transfer of funds. The user may then be prompted to enter the transfer code, the account code identifier, and the amount to be transferred. In addition, the user may be prompted to provide information regarding the user's account from which the funds are to be withdrawn and subsequently transferred to the account code holder's account. The user may use any form of account such as an account code 100, a checking account, credit card, bank card, or cash.

Funds may be transferred by telephone in a similar manner with the user dialing an established fund transfer phone number. The phone transfer system may then prompt the user for the relevant information in order to complete the transfer. If the user chooses to complete the transfer at a code retailer or other brick and mortar establishment, the user may provide the funds for the transfer in cash.

In a preferred embodiment, person-to-person transfers may involve private commerce via the Internet 120. For example, auction web sites, such as EBAY.com, may allow sellers to accept fund transfers to the seller's account code.

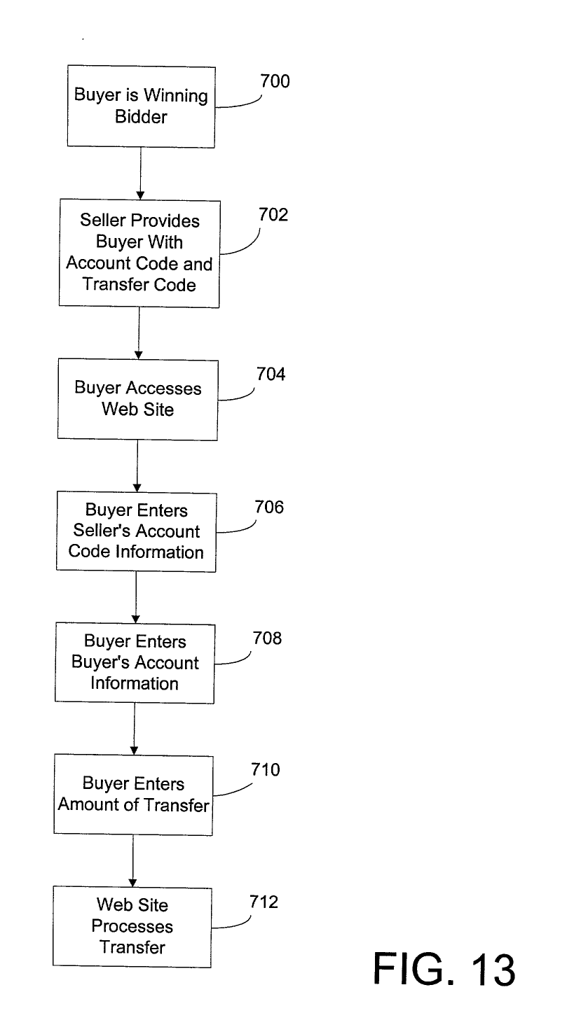

FIG. 13 illustrates one exemplary method of person-to-person transfers utilizing the present invention. At step 700, the buyer selects a good being sold by the seller. For example, the buyer may be the winning bidder on an auction web site. Once the winning bidder has been determined, the seller may provide the bidder with the seller's transfer code and account code identifier at step 702. The buyer may then, at step 704, access a web site, e.g., the card management web site 124 or another web site configured to allow transfers to or from account codes 100. At step 706, the buyer may be prompted to enter information regarding the seller's account code. At step 708, the buyer may then enter information regarding the buyer's account. As stated previously, the buyer may transfer funds from any type of account including an account code 100, a checking account, credit card, or bank card. The seller may then enter the amount to be transferred at step 710, and the web site may process the transfer at step 712.

This method of transfer may be also be used to wire money to another person. The user may transfer money in the above described manner to another person's account code.

Additionally, funds may be transferred in this manner by the account holder to add to the balance of his account. Therefore, once the account holder has purchased an account code 100, the account code holder may refuel the account using any other account. For example, the account holder may choose to use to use a credit card to add value to the balance of the account.

While particular embodiments and examples of the present invention have been described above, it should be understood that they have been presented by way of example only and not as limitations. Those of ordinary skill in the art will readily appreciate that other various embodiments or configurations adopting the principles of the subject invention are possible. The breadth and scope of the present invention is defined by the following claims and their equivalents, and is not limited by the particular embodiments described herein.

What is claimed is:

1. A system for managing a plurality of pre-paid money cards, comprising:
an account database comprising account codes identifying respective accounts, account balances identifying funds available funds from respective accounts, and account activation codes associated with the respective accounts;
an interface for receiving an account code and an account activation code from a consumer over a telecommunications network;
an account manager coupled to the interface for accessing the account database to confirm that the received account activation code is associated with the received account code, the account manage configured for requesting a secret code via the interface from the consumer over the telecommunications network after the account manager has confirmed that the received account activation code is associated with the received account code, the account manager configured for adding the secret code received from the consumer to the account database such that the secret code is uniquely associated with the respective account code.

2. The system of claim 1, wherein the interface is configured for receiving an authorization request comprising a fund request, an account code, and a secret code, and wherein the account manager is configured for accessing the account database for confirming that the secret code is associated with the account code, and for confirming that the fund request does not exceed a balance of the account identified by the account code.

3. The system of claim 2, further comprising a transfer system for transferring funds from the account after the account manager has confirmed that the fund request does not exceed the balance of the account identified by the account code, the account manager deducting the fund request from the balance in the account database.

4. The system of claim 2, wherein the fund request comprises a purchase price.

5. The system of claim 2, wherein the authorization request excludes information personally identifying the consumer.

6. The system of claim 1, wherein the account database excludes information identifying owners of respective accounts.

7. A system for anonymously transferring funds using pre-paid money cards, comprising:
an account database comprising account codes identifying respective accounts, account balances identifying available funds associated with respective accounts, and authorization codes associated with respective accounts;
an interface for receiving an account code and an authorization code from a consumer or seller over a telecommunications network;
an account manager coupled to the interface for accessing the account database to confirm that the received authorization code is associated with the received account code, the account manager configured for transferring funds from the account after the account manager has confirmed that the fund request does not exceed a balance of the account identified by the account code, the account manager deducting the fund request from the balance in the account database.

8. A method for securely transferring funds using an account database comprising a plurality of account codes and card activation codes, the account codes identifying accounts comprising respective account balances identifying available funds, the card activation codes uniquely associated with respective account codes, the method comprising:
providing the account codes and associated card activation codes to one or more distributors or consumers;
receiving an account code and a card activation code from a consumer via a telecommunications network;
accessing the account database to confirm that the received card activation code is uniquely associated with the received account code;
requesting a secret code from the consumer via the telecommunications network;
receiving a secret code from the consumer;
storing the secret code in the account database such that the secret code is associated with the account code; and
permitting secured transactions via the account code.

9. The method of claim 8, wherein the secret code replaces the card activation code associated with the account code when the secret code is stored in the account database.

10. The method of claim 8, further comprising adding value to the account balance.

11. The method of claim 8, further comprising:
receiving a transaction request from a seller over a telecommunications network, the transaction request comprising a price, an account code, and a secret code;
accessing the account database to confirm that the secret code is associated with the account code received with the transaction request and to confirm that the price does not exceed the account balance of the account code; and
debiting the price from the account balance.

12. A method for securely transferring funds, comprising:
purchasing an account code, the account code comprising an account balance and a card activation code associated therewith;
sending the account code and the activation code via a telecommunications network to an account manager to activate the account code; and
receiving a query from the account manager to provide a secret code to be associated with the account code after the account manager has activated the account code; and
sending a secret code to the account manager via the telecommunications network.

13. The method of claim 12, wherein the sending steps comprise accessing a web site communicating with the account manager.

14. The method of claim 12, wherein the account code is purchased from one of a vending machine storing a plurality of account codes, and a web site accessed via a computer network.

15. The method of claim 12, wherein the account code does not identify a purchaser.

16. The method of claim 12, further comprising:
accessing a vender site via a computer network;
selecting a product available via the vender site for purchase; and
sending the account code and the secret code to the vender site to provide payment for the purchase.

17. A method for a seller to sell products to a purchaser via a network, comprising:
receiving a prepaid account code and a secret code from a purchaser, the prepaid account code not identifying the purchaser;
determining whether the prepaid account code and secret code are valid; and
receiving payment for the products from a balance associated with the prepaid account code.

18. The method of claim 17, further comprising offering products for sale via a vender site accessible via a telecommunications network.

19. The method of claim 18, wherein the network comprises the Internet.

20. The method of claim 18, wherein the step of receiving the prepaid account code comprises receiving a purchase request from the purchaser at the vender site, the purchase request comprising the prepaid account code and the secret code.

21. The method of claim 20, wherein the purchase request excludes any information identifying the purchaser.

22. The method of claim 17, wherein the determining step comprises initiating a database look-up to determine whether the prepaid account code and the secret code are valid.

23. The method of claim 22, wherein the database look-up is initiated by transmitting the prepaid account code and the secret code to an account manager via a telecommunications network.

24. The method of claim 13, wherein the payment is received from the account manager after the account manager has verified that an account balance associated with the prepaid account code is sufficient to pay for the products being purchased.

25. A method for securely transferring funds using a prepaid account code, the prepaid account code comprising an account balance and an authorization code associated therewith, comprising:
receiving a transaction request via a telecommunications network, the transaction request comprising a value, a prepaid account code, an authorization code, and a destination;
confirming that the authorization code is associated with the prepaid account code;
verifying that the value does not exceed the account balance associated with the prepaid account code;
debiting the value from the account balance associated with the prepaid account code; and
transferring the value to the destination.

26. The method of claim 25, wherein the destination comprises a different prepaid account code, and wherein the value is transferred to the different prepaid account code via the telecommunications network.

27. The method of claim 25, wherein the transaction request is received from a vender, and wherein the destination comprises a vender account associated with the vender.

28. The method of claim 25, wherein the account belongs to an owner, and wherein the transaction request excludes any information identifying the owner.
